(19) United States
(12) Patent Application Publication
(10) Pub. No.: US 2011/0154184 A1
(43) Pub. Date: Jun. 23, 2011

(54) EVENT GENERATION FOR XML SCHEMA COMPONENTS DURING XML PROCESSING IN A STREAMING EVENT MODEL

(75) Inventors: George Andrei MIHAILA, Yorktown Heights, NY (US); Dung Kim Nguyen, San Jose, CA (US); Mayank Pradhan, San Jose, CA (US)

(73) Assignee: INTERNATIONAL BUSINESS MACHINES CORPORATION, Armonk, NY (US)

(21) Appl. No.: 13/035,743

(22) Filed: Feb. 25, 2011

Related U.S. Application Data
(62) Division of application No. 11/615,777, filed on Dec. 22, 2006.

(51) Int. Cl. G06F 17/21

(52) U.S. Cl. 715/234

(57) ABSTRACT

A method and computer program for processing structured documents follows a processing framework that enables generation of events corresponding to instance document elements and events corresponding to definition components in a single serial process. The process comprises creating a graph data structure in which nodes of the graph represent components of a document definition. The process further involves reading an instance document conforming to the document definition, identifying elements of the document that correspond to nodes of the graph, identifying a path between nodes of the graph that correspond to elements of the document, and traversing the path to generate a start event when moving from a parent node to a child node and an end event when moving from a child node to a parent node.

### RELATED APPLICATIONS

The present utility patent application is a divisional application and claims priority benefit, with regard to all common subject matter, of earlier-filed co-pending U.S. utility patent application titled “Event Generation for XML Schema Components During XML Processing in a Streaming Event Model” Ser. No. 11/615,777, filed Dec. 12, 2006, hereby incorporated in its entirety by reference into the present application.

### BACKGROUND OF THE INVENTION

1. Field of the Invention

The present invention relates to the field of processing structured documents. More particularly, the present invention relates to a processing framework that enables generation of events corresponding to instance document elements and events corresponding to definition components in a single serial process.

2. Description of Prior Art

The extensible markup language (XML) is a standard used to organize and tag elements of a document so that the document can be transmitted and interpreted between applications and organizations. XML has become an increasingly popular standard for communicating documents via the World Wide Web because XML can be used to describe not only how to display information in a document, but also to describe the meaning and content of information in the document.

Software operable to process XML documents follow an XML schema associated with each document. An XML schema is a set of rules, or data model, to which an XML document must conform, and XML schemas can vary from document to document. A schema may identify, for example, types of data fields contained in a document and the relationship between those data fields.

Processing XML instance documents typically entails parsing a document according to the schema definition and generating events associated with various elements of the document. Such events may include a start event when an element is first encountered and an end event when the software encounters an end tag associated with the element.

Unfortunately, existing XML processors are limited in that they generate events relating only to information contained in the document, and do not provide the flexibility needed by users who wish to employ a more robust event model that extends beyond the contents of a particular XML instance document.

Accordingly, there is a need for an improved method of processing XML documents that does not suffer from the problems and limitations of the prior art.

### SUMMARY OF THE INVENTION

The present invention provides a system and method of processing structured documents. More particularly, the present invention relates to a processing framework that enables generation of events corresponding to instance document elements and events corresponding to definition components in a single serial process.

A first embodiment of the invention is a computer program product comprising a computer usable medium including computer usable program code for processing a document that is structured according to a document definition.

The computer program product comprises computer usable program code for receiving event information corresponding to a first element of information within the document, for identifying a portion of the document definition describing the first element of information, and for generating a first event corresponding to the first element and for generating a second event corresponding to the portion of the document definition describing the first element, wherein the first event and the second event are generated as part of a single, serial process.

In a second embodiment, the computer program product comprises computer usable program code for identifying a first element of information within the document according to the document definition, for identifying a portion of the document definition describing the first element of information, and for generating a first event corresponding to the first element and a second event corresponding to the portion of the document definition describing the first element, wherein the first event and the second event are generated as part of a single, serial process.

In a third embodiment, the computer program product comprises computer useable program code for processing an XML schema and for processing event information relating to an instance XML document according to the XML schema. The computer useable program code for processing an XML schema includes code for identifying a first element declaration of an XML schema, for creating a graph data structure with a node corresponding to the first element declaration, for identifying a plurality of schema components (including model groups) and a second element declaration, wherein the plurality of schema components and the second element declaration relate to the first element declaration, and for identifying a relationship between the first element declaration, the plurality of schema components, and the second element declaration, and for computer usable program code for creating a node in the graph corresponding to each of the schema components and anode corresponding to the second element declaration, wherein the relationship is reflected in the graph.

The computer useable program code for processing event information relating to an instance XML document according to the XML schema includes code for receiving event information corresponding to a first element of an XML instance document corresponding to the first element declaration in the corresponding entity that defines each such element, for receiving event information corresponding to a second element of the XML instance document corresponding to the second element declaration, for identifying a path in the graph from the first element declaration to the second element declaration, wherein the path may include one or more of the plurality of nodes corresponding to the schema components, and for traversing the path, generating a start event corresponding to a child node when traversal is from a parent node to the child node, and for generating an end event corresponding to the child node when traversal is from the child node to the parent node.

These and other important aspects of the present invention are described in more fully in the detailed description below.

### BRIEF DESCRIPTION OF THE DRAWINGS

An embodiment of the present invention is described in detail below with reference to the attached drawing figures, wherein:

FIG. 1 is an exemplary system for implementing a method of generating events for definition components during structured document processing in a streaming event model;

FIG. 2 is a diagram illustrating certain XML schema components and relationships between the components;

FIG. 3 is an exemplary XML schema document conforming to the W3C XML Schema language;

FIG. 4 is an exemplary XML instance document conforming to the schema of FIG. 3;

FIG. 5 is a flow diagram showing certain steps involved in processing an XML schema definition as part of the method of FIG. 1;

FIG. 6 is a flow diagram showing certain steps involved in processing an XML instance document as part of the method of FIG. 1; and

FIG. 7 is a graph data structure including components of the schema of FIG. 3, wherein the graph is created pursuant to the process of FIG. 5.

### DETAILED DESCRIPTION OF A PREFERRED EMBODIMENT

The present invention provides a method for augmenting the functionality of a structured document processor, such as an XML parser, by generating events corresponding to definition components in addition to events generated by the document processor corresponding to document elements. The events corresponding to document elements and the events corresponding to definition components are generated in a single, serial process.

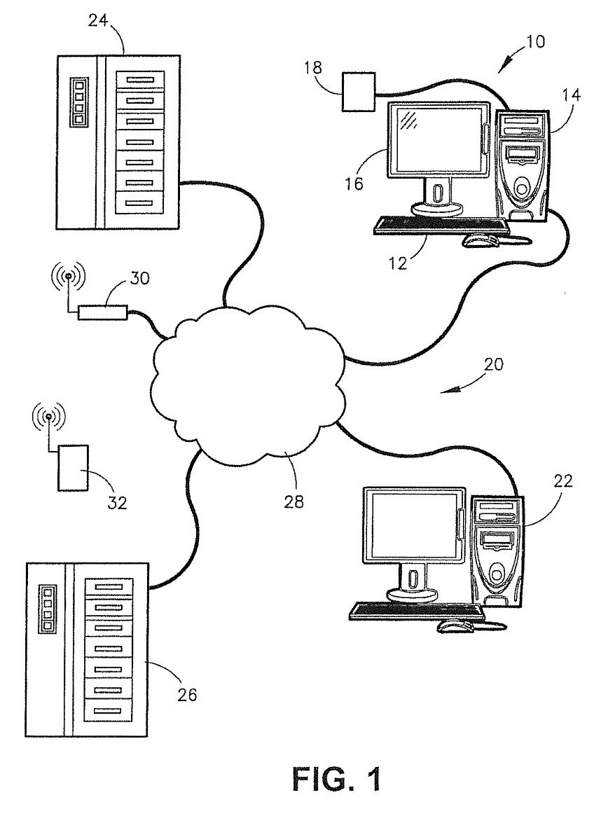

The method of the present invention is especially well-suited for implementation on a computer or computer network, such as the computer 10 illustrated in FIG. 1 that includes a keyboard 12, a processor console 14, a display 16, and one or more peripheral devices 18, such as a scanner or printer. The computer 10 maybe a part of a computer network, such as the computer network 20 that includes one or more client computers 10,22 and one or more server computers 24,26 interconnected via a communications system 28. The present invention may also be implemented, in whole or in part, on a wireless communications system including, for example, a network-based wireless transmitter 30 and one or more wireless receiving devices, such as a hand-held computing device 32 with wireless communication capabilities. The present invention will thus be generally described herein as a computer program. It will be appreciated, however, that the principles of the present invention are useful independently of a particular implementation, and that one or more of the steps described herein may be implemented without the assistance of a computing device.

The present invention can be implemented in hardware, software, firmware, or a combination thereof. In a preferred embodiment, however, the invention is implemented with a computer program. The computer program and equipment described herein are merely examples of a program and equipment that may be used to implement the present invention and may be replaced with other software and computer equipment without departing from the scope of the present invention.

The computer program of the present invention is stored in or on a computer-usable medium, such as a computer-readable medium, residing on or accessible by a host computer for instructing the host computer to implement the method of the present invention as described herein. The host computer may be a server computer, such as server computer 24, or a network client computer, such as computer 10. The computer program preferably comprises an ordered listing of executable instructions for implementing logical functions in the host computer and other computing devices coupled with the host computer. The computer program can be embodied in any computer-usable medium for use by or in connection with an instruction execution system, apparatus, or device, such as a computer-based system, processor-containing system, or other system that can fetch the instructions from the instruction execution system, apparatus, or device, and execute the instructions.

The ordered listing of executable instructions comprising the computer program of the present invention will hereinafter be referred to simply as “the program” or “the computer program.” It will be understood by those skilled in the art that the program may comprise a single list of executable instructions or two or more separate lists, and may be stored on a single computer-usable medium or multiple distinct media. The program may also be described as comprising various code segments, which may include one or more lists, or portions of lists, of executable instructions. Code segments may include overlapping lists of executable instructions—that is, a first code segment may include instruction lists A and B, and a second code segment may include instruction lists Band C.

In the context of this application, a “computer usable medium” or a “computer readable medium” can be any means that can contain, store, communicate, propagate or transport the program for use by or in connection with the instruction execution system, apparatus, or device. The computer-usable medium can be, for example, but is not limited to, an electronic, magnetic, optical, electro-magnetic, infrared, or semi-conductor system, apparatus, device, or propagation medium. More specific, although not inclusive, examples of the computer usable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-usable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

As explained above in the section titled “DESCRIPTION OF THE PRIOR ART,” XML is a standard used to organize and tag elements of a document so that the document can be transmitted and interpreted between applications and organizations. Use of XML involves XML schemas and XML instance documents. An XML schema is a set of rules, or data model, to which an XML document must conform. An XML instance document is a data object conforming to, for example, the World Wide Web Consortium (“W3C”) recommendation at http://www.w3.orgfTRlREC-xml or a previous version of that recommendation. XML instance documents and XML schemas are specific examples of structured documents and document definitions, respectively.

Examples of documents include, but are not limited to, an electronic file residing in a computer memory or a storage device, a collection of data elements received via an electronic communications medium, and a paper or other tangible medium containing printing or other indicia of data or information.

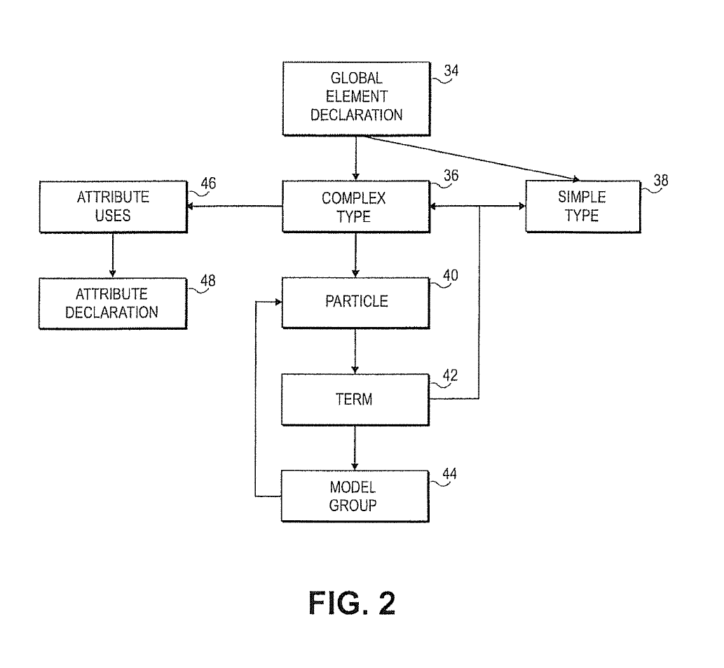

Various definition components specified by W3C recommendation http://www.w3.orgtrR/xmlschema-1/are illustrated in FIG. 2, which also indicates relationships between various definition components. A global element declaration 34 may be either of complex type 36 or simple type 38. An element of complex type has one or more embedded child elements, one or more attributes, or both. An element of simple type has no embedded child elements or attributes, and includes only child text nodes. An XML schema includes one or more global element declarations, and an XML instance document is rooted at only one global element, but may include one or more global elements corresponding to each global element declaration of the XML schema definition.

A complex type has a component called a particle 40, which enforces cardinality constraints-minimum (“minOccurs”) and maximum (“maxOccurs”) occurrences of an element. The particle has a property called “term” 42, which can be a wildcard, element declaration, or a model group. If the term is an element declaration, it can be either complex 36 or simple 38. The term may alternatively be a model group, which defines how content will be laid out—sequence, choice, or all. Items of a sequence model group must appear in a particular sequence, while anyone item of a choice model group may appear. The content model “all” implies that all the items of the content model can appear in any order. The model group 44 may contain many particles, wherein each particle of the model group enforces cardinality constraints on an individual item of the model group through minOccurs and maxOccurs properties. This allows an infinite depth recursion of model group, particles, and element declarations.

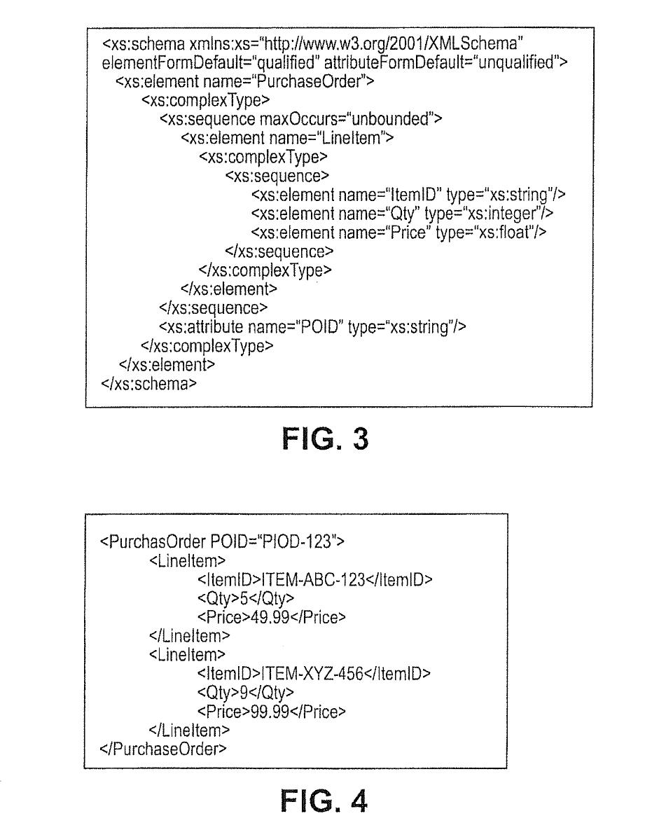

An exemplary XML schema is illustrated in FIG. 3. The schema of FIG. 3 includes, among other things, a global element declaration for a complex element called “PurchaseOrder” that includes an embedded child element called “LineItem,” which in turn includes a sequence of three embedded child elements called “ItemID,” “Qty,” and “Price.” An exemplary XML instance document corresponding to the schema of FIG. 3 is illustrated in FIG. 4. The document of FIG. 4 includes a single PurchaseOrder element and two LineItem elements. An ItemID element, Qty element, and Price element pertain to each of the LineItem elements.

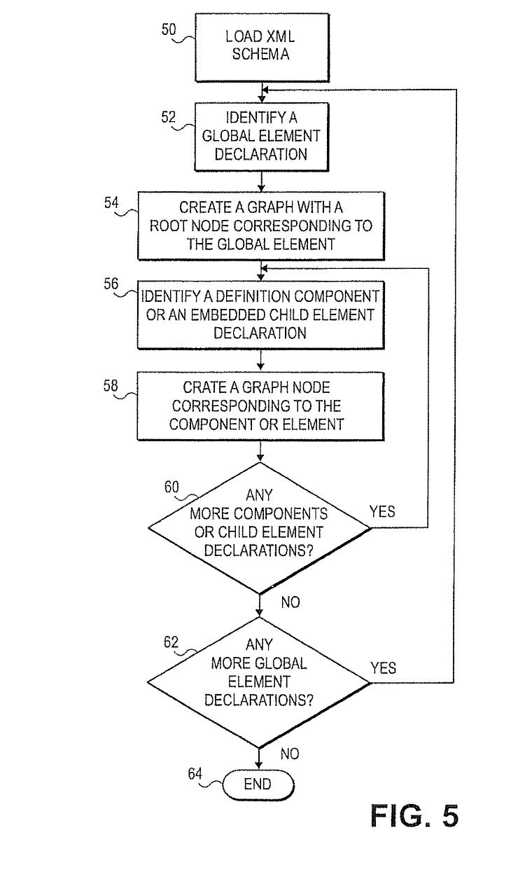

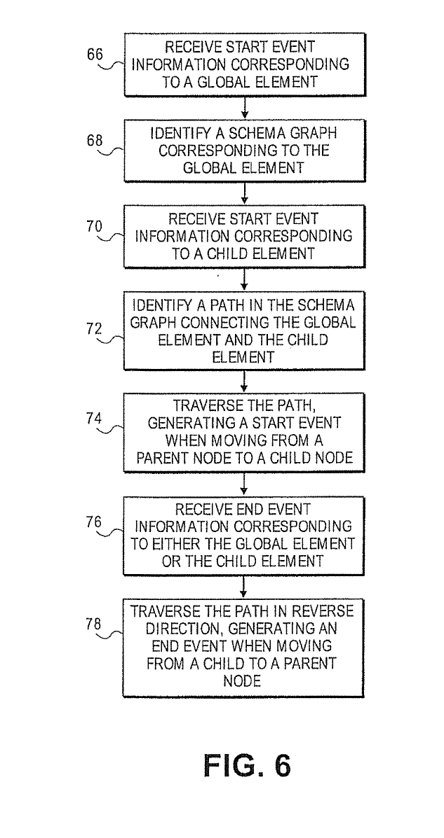

FIGS. 5 and 6 each illustrate a flow diagram of steps involved in processing XML instance documents, wherein FIG. 5 generally includes steps involved in processing an XML schema document and FIG. 6 generally includes steps involved in processing an XML instance document.

In processing the schema, the program first loads an XML schema, as depicted in block 50. This step may involve, for example, reading a “.xsd” file or similar document containing an XML schema, such as the schema shown in FIG. 3. Alternatively, the program may load an XML schema by transferring a data structure representing the schema from a memory buffer. The program then identifies a global element declaration, as depicted in block 52. An exemplary global element declaration is the line containing “element name=“PurchaseOrder” in FIG. 3. When the program identifies a global element declaration, it creates a graph data structure with a root node corresponding to the global element, as depicted in block 54.

The program then identifies a definition component or an embedded child element declaration, as depicted in block 56. In this step, the program determines to which global element declaration each child element declaration is related, and to which (if any) element declaration each definition component is related. The program then creates a graph node corresponding to the definition component or child element declaration, as depicted in block 58. The node is placed in the graph to reflect a relationship between the definition component and other components and element declarations in the schema definition. For example, if the definition component is a particle component of a global element declaration, the node corresponding to the component is a child of the node corresponding to the global element declaration.

The program determines whether there are any more definition components or child element declarations to process, as depicted in block 60. If so, the program identifies the next definition component or child element declaration, as depicted in block 56. If not, the program determines whether there are any more global element declarations to process, as depicted in block 62. If so, the program identifies the next global element declaration, as depicted in block 52, and processes any components or child element declarations corresponding to the global element declaration. If there are no more global element declarations to process, the program has completed analyzing the XML schema and may use the graph corresponding to the definition to analyze an XML instance document that conforms to the XML schema definition.

The above-described method of processing an XML schema may be used or adapted to process virtually any structured document definition. However, the method will now be described more particularly in terms of the XML schema to illustrate one particular implementation. The program identifies a global element declaration, as explained above. If the global element is declared to be of complex type, a corresponding “Complex Type” node is created and attached to the global element node in the graph. The complex type definition is processed, whereby cardinality information (if the complex type has none-empty element content) and/or attribute information are discovered and a corresponding “Particle” node, “Attribute Use” node, or both are created and attached to the Complex Type node in the graph. The particle contains a model group, resulting in the creation of a “Model Group” node, attached to the Particle node. Processing of the model group leads to the discovery of one or more element declarations, which are processed in the same manner as global element declarations, except that the element nodes created are attached to the Model Group node in the graph, rather than being a root node. The processing of schema components continues in the same manner for all descendant element declarations. Then the program repeats the procedure on the next global element declaration, resulting in another graph. The analysis of the XML schema is complete when all global element declarations are processed.

An exemplary method of processing an XML instance document is illustrated in FIG. 6, wherein the method involves using the graph data structure created in the process of FIG. 5 to process an instance XML document that conforms to the schema used to create the graph.

The program invokes a conventional XML parser, passing the instance document and the XML schema as input. The XML parser sends a “startElement” event for the root element, as depicted in block 66, and the program identifies the correct schema graph to use for the rest of the processing of the instance document based on the startElement, as depicted in block 70. The root node of this graph becomes the current node. For each subsequent start element event received from the parser and corresponding to element Eᵢ, a path Pᵢ from the current node to the node corresponding to Eᵢ in the schema graph is calculated, as depicted in block 72. The program then traverses the path Pᵢ, as depicted in block 74, wherein the nature of path Pᵢ is such that traversal down the graph (from parent to child) causes a start event corresponding to the child node, and traversal up the graph (from child to parent) causes an end event for the child node. Only one element node (corresponding to element Eᵢ) is in the path Pᵢ. The program receives end event information corresponding to either the global element or the child element, as depicted in block 76. Upon receiving the end event information, the program traverses the path in reverse direction, generating an end event corresponding to a child node each time it moves from the child node to a parent node. Furthermore, this traversal should not cause violation of any rules described below for the Particle node, Model Group node, or a Wildcard node.

A particle node is started in response to the start of an element that is its descendant in the XML component hierarchy (see FIG. 2). However, if the particle is already started, any further occurrence of child items results in an increase in occurrences property of the particle, until the occurrences value of the particle is the same as the maximum number of occurrences for the particle.

The following events mark the end of a particle node: I) the end of an element that is an ancestor of the particle node in the XML component hierarchy (the element causing an end event for the particle must be the closest element ancestor of the particle node); 2) the start of an element that is not a descendant of the particle in question; and 3) the start of a child node after the occurrences property of the particle node is equal to the maximum allowed.

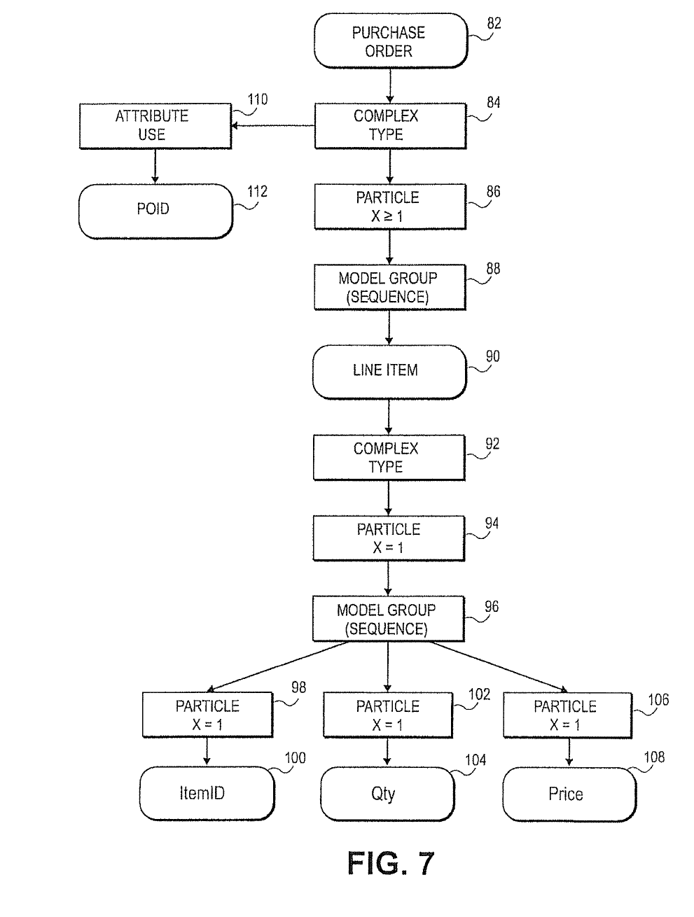

The start of a model group depends on the type of model group. If the model group is of type sequence, tile start event occurs in response to the start of a child node in the XML schema component hierarchy. Note that the child is either an element node or a particle node. In a model group of type sequence, however, the start of a child node does not always result in the start of the model group. With reference to the data structure of FIG. 7, if an instance of model group of type sequence has already been started and a child node occurs which is to the right of the most recently previously occurring child, for the same occurrence of the model group, then the model group is not restarted. If an instance of the model group of type sequence has already been started and a start event occurs for a child node which is either to the left of a previously occurring child node or is the same as the previously occurring child node, in the same occurrence of the model group, then the occurrence of model group is ended and a new occurrence is started.

The end of a model group can also be triggered by the start of an element that is not a descendant of the model group in the XML component hierarchy, which essentially triggers the end of the model group's parent particle node.

If the model group is of type choice, the start of each child node causes the start of the model group. The end of each instance of child node causes the end of the current instance of the model group.

If the model group is of type all, the start of any child node causes the start of this model group. However, the model group is not started for each occurrence of the child node; the start of the model group happens only for the first occurrence of any of its child nodes.

The end of a model group of type all is triggered by the start of an element that is not a descendant of the model group in the XML component hierarchy, which essentially triggers the end of the model group's parent particle node.

Special rules may also be employed to determine the beginning and end of wildcard nodes. While wildcard nodes were not processed as part of the example set forth above, it is possible to have such a node for a schema that contains wildcard declarations. The start of a wildcard node is triggered by the start of an element such that its qualified name matches the specified wildcard constraints. The end of element corresponding to the element in the XML document that caused the start of wildcard marks the end of wildcard node.

An advantage of the present invention over the prior art is that events corresponding to XML instance document elements and schema definition components are generated in a single, serial process without the need to perform two separate processes. The program is operable to generate both start events and end events corresponding to each element and each definition component.

FIG. 7 illustrates an exemplary graph corresponding to the XML schema definition set forth in FIG. 3 and created by the process of FIG. 5. The root node 82 corresponds to the global element declaration “PurchaseOrder,” and child nodes 90,100,104,108 correspond to element declarations “LineItem,” “ItemID,” “Qty,” and “Price,” respectively. The attribute declaration node 112 corresponds to the attribute “POID” attached to the “PurchaseOrder” global element declaration node. The nodes 82,90,100,104,108 are element and attribute declarations, instances of which appear in instance documents, such as the document set forth in FIG. 4.

Appendix A presents a table of events corresponding to only information encountered in an XML instance document, namely elements and attributes associated with the elements. Appendix B presents an exemplary table of events generated in a process that considers information from the schema definition of FIG. 3 as well as information encountered in the XML instance document of FIG. 4. For simplicity, the table of appendix B only includes events corresponding to particle and model group definition components. Alternatively, the program may generate events corresponding to all definition components, anyone type of definition component, or any combination of definition components.

As described above, the invention is operable to cooperate with conventional XML processing software to generate events corresponding to schema components in addition to the events generated by the conventional XML processing software that correspond to instance document elements.

An advantage of the present invention over the prior art is that events corresponding to XML instance document elements and schema definition components are generated in a single, serial process without the need to perform two separate processes. The program is operable to generate both start events and end events corresponding to each element and each definition component. As depicted in block 126, the program generates a start event corresponding to a child node when traversing from a parent node to the child node. When traversing from a global element declaration, for example, to an element type component, the program generates a start event for the element type component wherein the type (i.e., complex or simple) is handled as an event parameter. The program generates an end event corresponding to the child node when traversing from the child node to the parent node, as depicted in block 128.

Having thus described a preferred embodiment of the invention, what is claimed as new and desired to be protected by Letters Patent includes the following:

1. A computer program product comprising a computer usable medium including computer usable program code for XML processing and event generation, said computer program product comprising:
computer usable program code for identifying a first element declaration of an XML schema;
computer usable program code for creating a graph data structure with a node corresponding to the first element declaration;
computer usable program code for identifying a plurality of schema components and a second element declaration, wherein the plurality of schema components and the second element declaration relate to the first element declaration, and for identifying a relationship between the first element declaration, the plurality of schema components, and the second element declaration;
computer usable program code for creating a node in the graph corresponding to each of the schema components and a node corresponding to the second element declaration, wherein the relationship is reflected in the graph;
computer usable program code for receiving event information corresponding to a first element of an XML instance document corresponding to the first element declaration;
computer usable program code for receiving event information corresponding to a second element of the XML instance document corresponding to the second element declaration;
computer usable program code for identifying a path in the graph from the first element declaration to the second element declaration, wherein the path includes at least one of the plurality of nodes corresponding to the schema components; and
computer usable program code for traversing the path, generating a start event corresponding to a child node when traversal is from a parent node to the child node, and for generating an end event corresponding to the child node when traversal is from the child node to the parent node.

2. The computer program product of claim 1, wherein at least one of the nodes is a complex type node, wherein the complex type node is a parent node to at least one of a particle node and an attribute use node attached to the complex type node.

3. The computer program of claim 1, wherein at least one of the nodes is a model group node attached to a particle node, wherein the model group node defines how content of a model group is laid out.

4. The computer program of claim 3, wherein the model group node is a child node of the particle node and the particle node is a parent node of the model group node.

5. The computer program of claim 1, wherein the first element declaration is a global element declaration.

6. The computer program of claim 5, further comprising computer usable program code for creating a root node in the graph corresponding to the global element declaration, wherein the root node is a parent node.

7. The computer program of claim 1, wherein at least one of the nodes is a wildcard node having specified wildcard constraints.

8. The computer program of claim 1, wherein at least one of the nodes is a particle node configured such that each occurrence of a child item corresponding to the particle node increases an occurrences property of the particle node until a maximum number of occurrences for the particle node is reached.

9. The computer program of claim 1, wherein the start event and the end event are generated as part of a single, serial process.
